(19) United States
(12) Patent Application Publication
(10) Pub. No.: US 2022/0270068 A1
(43) Pub. Date: Aug. 25, 2022

(54) PAYMENT NETWORK AND METHOD FOR PAYING RECURRING BILLS

(71) Applicant: Highline Technologies Inc., Coppell, TX (US)

(72) Inventor: Geoffrey Brown, Coppell, TX (US)

(21) Appl. No.: 17/674,612

(22) Filed: Feb. 17, 2022

Related U.S. Application Data
(60) Provisional application No. 63/151,588, filed on Feb. 19, 2021.

(51) Int. Cl. G06Q 20/24; G06Q 40/00

(52) U.S. Cl. CPC G06Q 20/24; G06Q 40/125; G06Q 40/128

(57) ABSTRACT

The disclosure relates to a method for bills to be paid automatically from sources of income. The disclosure also relates to a method for determining a risk of credit loss associated with paying recurring bills through direct deposit repayments. An example method includes collecting one or more data associated with one or more customers; receiving historical data; creating a model based on the historical data; predicting one or more activities of the one or more customers based on the one or more data and the model; determining a risk of credit loss associated with the one or more customers based on the prediction of the one or more activities; and providing the risk of credit loss to one or more billers.

### CROSS-REFERENCE TO RELATED APPLICATION(S)

This application claims the benefit of and priority to U.S. Provisional Application No. 63/151,588, filed on Feb. 19, 2021, entitled “A PAYMENT NETWORK AND METHOD FOR PAYING RECURRING BILLS,” which is hereby incorporated by reference in its entirety.

### TECHNICAL FIELD

The present systems and methods are directed to a payment network and a method for paying recurring bills.

### BACKGROUND

In recent years, more and more customers get charged for late fees or overdraft fees if the customers miss recurring bills such as credit cards, utilities, rent, cell phone bills, or insurance. Some customers choose to pay the recurring bills using their bank accounts linked to direct deposit payments from their employers. However, if the customers frequently change jobs or have gaps in pay, current payment network and current method for paying the recurring bills may have some problems when handling these situations. The customers still end up being charged for the late fees or the overdraft fees. Therefore, there is a need for a new payment network and a new method for paying recurring bills in order to solve these problems.

### SUMMARY

In one aspect, the subject matter of this disclosure relates to a method for bills to be paid automatically from sources of income. In another aspect, the subject matter of this disclosure also relates to a method for determining a risk of credit loss associated with paying recurring bills through direct deposit repayments. The method may include collecting one or more data associated with one or more customers; receiving historical data; creating a model based on the historical data; predicting one or more activities of the one or more customers based on the one or more data and the model; determining a risk of credit loss associated with the one or more customers based on the prediction of the one or more activities; and providing the risk of credit loss to one or more billers.

These and other objects, along with advantages and features of embodiments of the present invention herein disclosed, will become more apparent through reference to the following description, the figures, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is an exemplary payment network, according to an embodiment of the present disclosure;

FIG. 2 is an exemplary online dashboard hosted by a payment server, according to an embodiment of the present disclosure;

FIGS. 3-7 are exemplary customer events which trigger a customer communication or payments account change, according to an embodiment of the present disclosure;

FIG. 8 is a flow chart of a system for determining a risk for credit loss associated with paying recurring bills through direct deposit repayments, according to an embodiment of the present disclosure;

FIG. 9 is a schematic of a user device for performing a method, according to an embodiment of the present disclosure;

FIG. 10 is a schematic of a hardware system for performing a method, according to an embodiment of the present disclosure; and

FIG. 11 is a schematic of a hardware configuration of a device for performing a method, according to an embodiment of the present disclosure.

### DETAILED DESCRIPTION

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art.

It should be understood that the order of steps or order for performing certain actions is immaterial so long as the invention remains operable. Moreover, two or more steps or actions may be conducted simultaneously.

With reference to the drawings, the invention will now be described in more detail. The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

In one embodiment, the system in the present disclosure describes a payment network. The payment network allows for recurring bills to be paid by payroll direct deposit. In some embodiments, paying bills automatically from future income greatly improves the rate bills are paid on time.

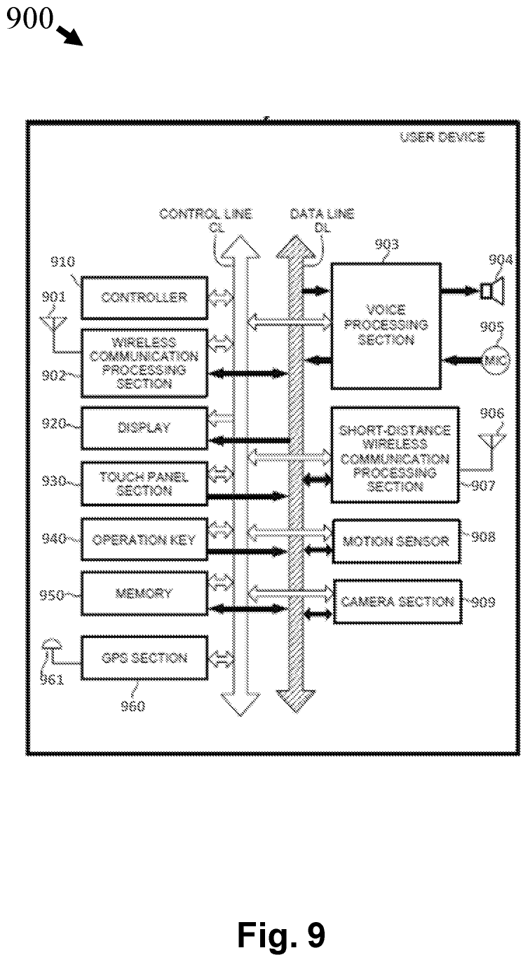

For customers, the system in the present disclosure simplifies finances and makes it possible to automatically pay bills (e.g., credit cards, utilities, rent, cell phones, insurance, etc.) without worrying about late fees or overdraft fees. The system in the present disclosure may be presented to the customers on a user device 900 which is discussed later in FIG. 9.

For lenders, the system in the present disclosure creates an enormous reduction in costs, which in turn makes it possible for many people to access lower cost services. The system in the present disclosure may also be presented to the lenders on a user device 900 which is discussed later in FIG. 9.

In some embodiments, customers frequently change jobs or have gaps in pay, so the system in the present disclosure may provide customer service, credit, savings, and employment insurance to better handle these situations.

In one embodiment, the network in the present disclosure provides services to a wide variety of companies in lending and personal services that rely on periodic and stable payment flows to provide their services. The company helps consumers access credit, get favorable terms for products, and improve their traditional credit scores by first using their career as their credit.

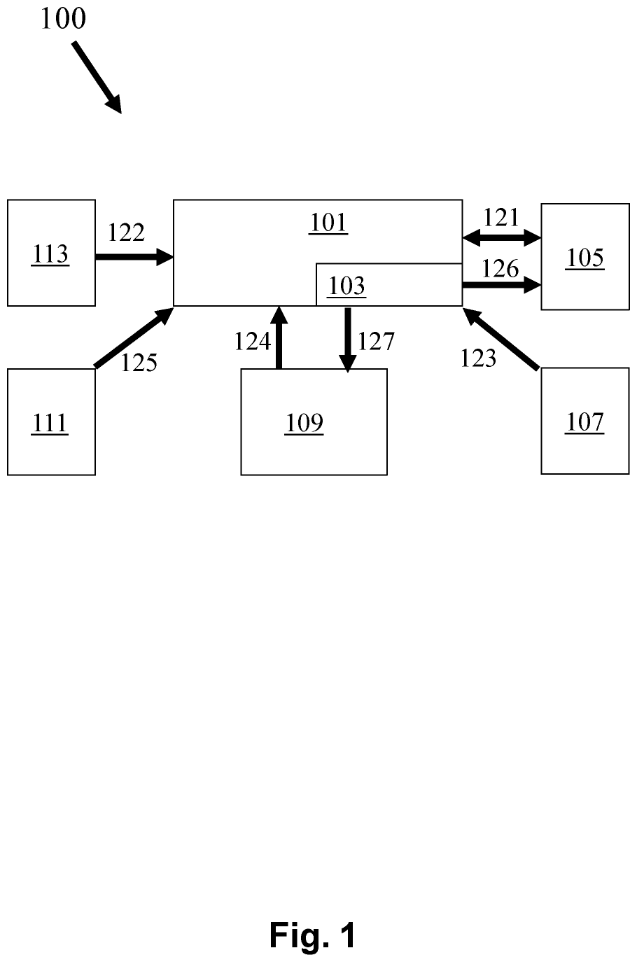

Referring to FIG. 1, this figure illustrates an exemplary payment network, according to an embodiment of the present disclosure.

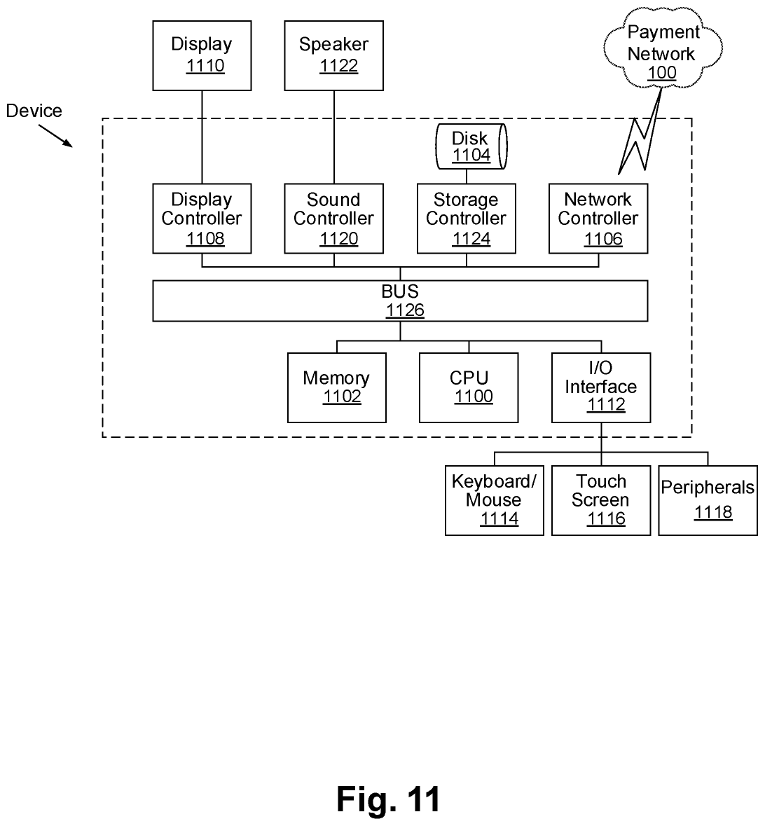

In one embodiment, the payment network 100 in FIG. 1 includes a payment server 101 that uses a method 121 such as exchanging information with a biller 105 on a recurring basis on an amount and date bills are due, and the availability of funds for payment in a payment account 103 (e.g., a for the benefit-of account, or similar account) managed by the payment server 101. The hardware functionalities of the payment network 100 is discussed in detail later in FIG. 11. The payment account 103 is a commercial account held by the service provider for executing payments for the benefit of the customer, not a general purpose consumer asset account (e.g., a consumer savings or checking/debit account). For example, a customer's employer that provides a payroll platform may be instructed to send a direct deposit of a portion or all of the customer's net pay to a payment account 103, where that financial account is the payment account 103 in FIG. 1. The payment server 101 in FIG. 1 may assign individual routing and account numbers to individual customers or individual customer payment arrangements so that the payment server 101 may determine purpose of any direct deposits received, however the funds are all held in a pooled account for payment processing.

In one embodiment, funds are received from a recurring source of deposits, such as an employer's account. Funds may be received by a method 122 from a source of automatic deposits 113 by automated clearing house (ACH) or other mechanism for electronic payments to the payment server 101.

In one embodiment, the payment server 101 may use a method 123 to receive funds for payment from an insurance account 107 in the event of a qualifying event that impacted the source of automatic deposits 113, such as disability insurance or employment insurance program. The insurance account 107 may be an insurance or other income-protection program. Fees or premium for the insurance account 107 may be paid either by the consumer or the biller 105 of the user device 900. The insurance account 107 may be part of the payment network 100 or provided by a third party.

In one embodiment, the payment server 101 associated with the payment network 100 may use a method 124 to access additional funds from a consumer deposit account 109 to complete a payment to a biller 105. The consumer deposit account 109 may be checking or savings account held by the customer. Funds may be transferred by the ACH or by other mechanism of electronic payment. The consumer deposit account 109 may be part of the payment network 100 or provided by a third party. The third party may be banks that the customer uses.

In one embodiment, the payment server 101 may use a method 125 to access additional funds from a consumer lending account 111 if needed to complete a payment to a biller 105. The consumer lending account 111 may be a credit card, an early wage access service (e.g. Bridgit), or a bank line of credit. Funds may be transferred by the ACH, card, or by other form of electronic payment. The consumer lending account 111 may be part of the payment network 100 or provided by a third party. The consumer lending account 111 may be repaid as a biller 105 on the payment network 100 or repaid separately. For example, if a consumer is short by $100 and the shortage is covered from their credit card, then the credit card can also be a recipient of payments from future paychecks.

In one embodiment, the payment server 101 of the payment network 100 may use a method 126 to send payment amounts to the biller 105. This may be completed by an ACH debit initiated by the biller 105, or by payments generated by the payment server 101 in individual transactions or in bulk settlement. In some embodiments, multiple billers may be paid from a same account, with a mechanism to prioritize payments. For example, the customer may be able to view their list of enrolled bills in order of priority. They may change the order of priority at any time. If there are insufficient funds received to pay all bills, then the highest priority bills may be paid first. The customer is notified when this occurs so that they can pursue other payment options for the amounts not paid.

In one embodiment, a method 127 including excess funds to be collected for payment may be sent to the customers deposit account 109. For example, if the payment account 103 receives $100 from the consumer's paycheck but the payment due on the consumer's credit card is only $40, then $40 goes to the credit card and $60 excess funds goes to the consumer's checking account. Accordingly the payment account 103 in the payment network 100 is a payment alternative to card, ACH, or checks.

In one embodiment, the excess funds are based on a projection of direct deposits received and bill amounts due. As soon as the payment server 101 projects holding excess funds, then these funds are released to the customer. The payment server 101 do not wait until after the bill payment is complete to identify what is remaining as a traditional checking account does.

In one embodiment, financial know your customer (KYC) onboarding for the payment account 103 by the payment server 101 may be assisted by receiving customer information from the biller 105, from the payroll platform (e.g., source of automatic deposits 113), and from other third party sources. The know your customer (KYC) may be a regulatory requirement of financial businesses to be able to identify the customer.

In one embodiment, the customer may set up a direct deposit split by providing digital access to their payroll platform, e.g., Gusto, Paychex, or ADP. The customer is asked to identify the customer's employer and the customer's payroll platform and then log into that payroll platform. With access, the payment server 101 may read the customer's information including current pay schedule and direct deposit information. The payment server 101 presents the customer with the changes needed to direct deposit to pay the bill, e.g., from full balance to a bank checking account ending in 1234 changing to $43.00 to the payment account 103 managed by the payment server 101. The customer through the granted payroll platform access can instruct the source of automatic deposits 113 to send the remainder of a paycheck to a checking account. (e.g., the bank checking account ending in 1234). Once the customer confirms the changes, then the payment server 101 uses the payroll platform access to establish the new direct deposit to the payment account 103. The direct deposit may go to a “for benefit of” (FBO) account assigned to the customer. In some embodiments, for the payment server 101, the customer redirects the entire income to the payment account 103 and any amounts not needed for payment to a biller 105 may be promptly distributed to the consumer deposit account 109.

In one embodiment, the payment server 101 may obtain the customer's banking information and permission to enable the payment server 101 to seamlessly move to debiting from the consumer deposit account 109 as a backup to the direct deposits received into the payment account 103. The payment server 101 of the payment network 100 may use a third party to validate a customer's bank account or validate the account through access to the consumer's payroll platform. This bank account validation is also needed for disbursement of any excess direct deposits. The third party may be a Plaid or Finicity.

In one embodiment, after a customer is successfully enrolled and has updated their payroll direct deposit, the payment server 101 provides methods for the biller 105 to receive payments. The biller 105 may choose to debit amounts due from the payment account 103 or to receive payments initiated by the payment server 101. If the biller 105 is debiting payments, then biller 105 is provided the deposit routing and account number for a payment account 103 for the biller 105 to debit from. Debits from the biller 105 against the payment account 103 may be settled by the payment server 101 against direct deposits, insurance account 107, consumer lending account 111 or the consumer deposit account 109. If none of these sources has sufficient funds, then the ACH debit may be declined for insufficient funds. Enabling these payment methods for the customer helps them easily maintain on time payments, and it helps biller 105 get paid on time and in full. Alternatively, the customer may elect, if enabled by the biller 105, for the payment server 101 to pay the amount due the same day as funds is received from direct deposit. In this method, if a direct deposit is not received as expected then the payment server 101 may complete the payment from the insurance account 107, consumer lending account 111 or the customer deposit account 109 at an interval of time between when the direct deposit was expected and when the payment is due. The interval of time may be any time between the day the paycheck is expected and when the payment is due.

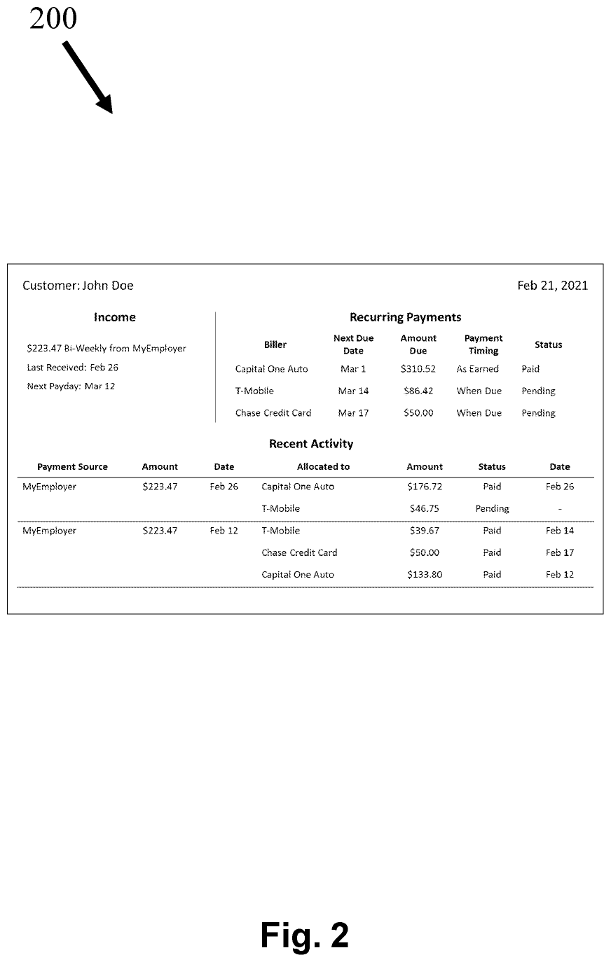

Referring to FIG. 2, this figure illustrates an exemplary online dashboard 200 hosted by a payment server, according to an embodiment of the present disclosure.

In one embodiment, the customer may view these transactions in an online dashboard 200 hosted by the payment server 101 as in FIG. 2. The online dashboard 200 may use the display 920 for displaying to the customer of the user device 900. The hardware functionalities of the display 920 are discussed later in FIG. 9.

In one embodiment, the customer may be able to set a priority of bills to be paid and a priority of funding sources to be used. By default, alerts are on. The customer can set alerts to be notified on each direct deposit received and each payment made. The alerts may be associated with the speaker 904 and the voice processing section 903, which are discussed later in FIG. 9. The customer may also route excess funds or deposit funds from the customer's primary checking account. The online dashboard 200 may also be available in a mobile application, which can additionally provide value with notifications and location tracking. The location tracking may be controlled by the GPS section 960 in the user device 900, which is discussed later in FIG. 9.

In one embodiment, the payment server 101 provides ongoing reporting to the billers 105 on customer activity. This may give billers 105 advance notice of customers that may not pay the amount due and the reason why.

### Savings

In one embodiment, customers of the payment network 100 that have an excess amount of direct deposit from payroll can route the excess funds to a savings account accessible by the customer. The customer may transfer funds out from the savings account by ACH or other methods using the payment server 101.

### Insurance

In one embodiment, the payment platform includes insurance to help pay bills and the payment platform is located in the payment network 100. This can benefit both the consumer and billing partner in keeping bills paid during gaps in income. The insurance may cover scenarios such as death, disability, and/or involuntary unemployment.

### Credit

In one embodiment, the payment platform offers access to credit for the purposes of covering shortfalls in paying bills through the payment network. Shortfalls can occur if a customer has too little income or a higher than expected bill amount. Income could be reduced by having fewer hours, taking a leave of absence, garnishments, or loss of employment. Credit may be extended to the consumer based on their credit risk profile.

### Data Services

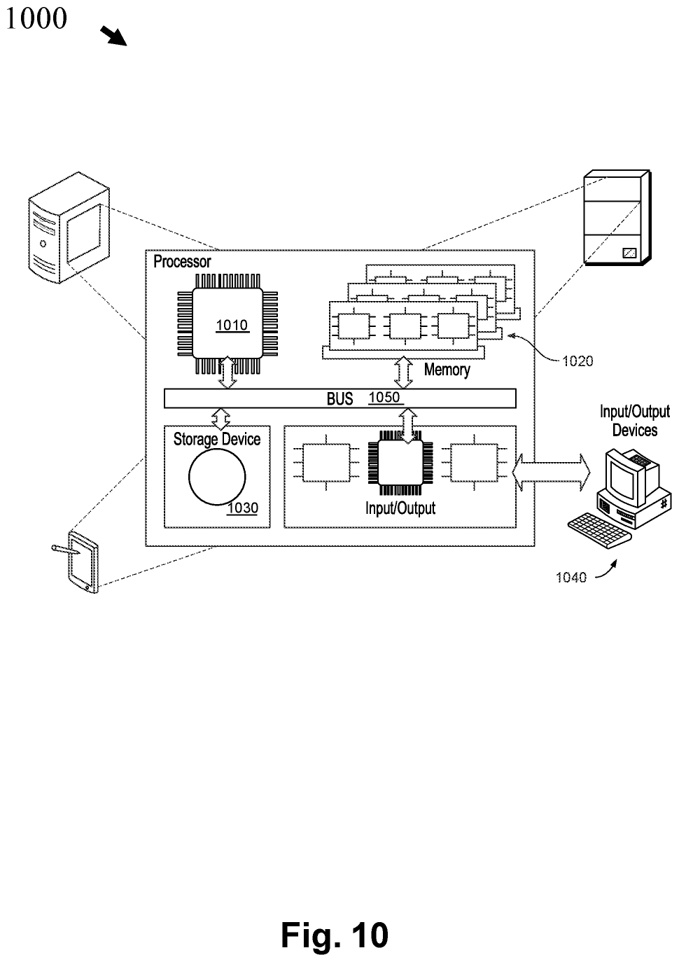

In one embodiment, the payment server 101 supports billers 105 in credit risk management and customer origination. Forecasting risk for a loan being repaid by direct deposit lacks ideal sources of data for decision making. Data collected by the payment server 101 may be used to predict who is likely to remain at their employer or to update to a new direct deposit from a new employer. The prediction may be performed by the processor 1010, which is discussed later in FIG. 10. The data collected by the payment server 101 may include employment tenure, income, overtime pay, bonuses, trend in income, title, company, and industry, and the data may be stored in the memory 950, which is discussed later in FIG. 9. The prediction for who is likely to remain at their employer or to update a new direct deposit from a new employer may be based on a model using historical platform data. The model may be created by the processor 1010 which is discussed later in FIG. 10. The payment server 101 may collect the data for prediction above and track which individuals remain employed and pay with the service. This is the most critical factor in predicting expected credit losses when lending with direct deposit repayments. The payment server 101 provides the analysis of data to billers 105 to assist in the billers' decision making.

### Account Management

In one embodiment, the account management include customer communications. The payment server 101 includes automated service email programs. The automated service email programs include post-onboarding email. For example, the customer is sent an email welcoming them and providing a link to the online portal. Additional calls to action may include linking to their checking account or enrolling in employment insurance.

In one embodiment, the automated service email programs include direct deposit received. For example, the customer is notified when a direct deposit is received. The email includes the amount received, current net balance, upcoming bills due.

In one embodiment, the automated service email programs include payment made. For example, the customer is notified when a payment is made. The email includes the amount paid, current net balance, upcoming bills due. This notice may be combined with notice of direct deposits received when payments are made on the same day.

### Customer Access

In one embodiment, the customer may be able to access their account information online. The information available includes personal information such as name or address; contact information such as phone or email; linked bank account information such as routing number, account number, if automatically debiting; registered bills such as biller name, product name, current balance, next payment date, next payment amount, final payment date, if employment insurance enrolled, bill priority; registered direct deposits such as employer name, direct deposit amount, last direct deposit date, next direct deposit date; rending payment amounts; transaction history such as list of deposits and debits including the biller/employer name, transaction amount, insurance fee amount, transaction date, net balance; transaction schedule such as list of expected direct deposits and debits for the upcoming period including the biller or employer name, transaction amount, insurance fee amount, transaction date; and documents such as terms and conditions, privacy policy, ACH agreements, electronic disclosure agreement, any uploaded documents.

### Customer Initiated Actions

In one embodiment, the customer-initiated actions may be by email, phone and on the online portal. The customer may Link a new bank account (e.g., via Plaid/Finicity); remove a linked bank account; elect or remove election to debit automatically from the consumer deposit account when direct deposits are not received; make an one-time deposit from the consumer deposit account to cover a shortfall; route excess funds to the consumer deposit account remove direct deposit (e.g., via Payroll Platform access); update direct deposit source (e.g., via Payroll Platform access); increase direct deposit amount to fund a savings balance; reduce direct deposit amount to stop funding savings; set priority of bills to be paid, if multiple; update address; update phone number; update email address; enroll in employment insurance; cancel employment insurance; configure alerts for when direct deposits are received (e.g., none, to email); configure alerts for when payments are made (e.g., none, to email); dispute direct deposit as fraud; dispute direct deposit as non-fraud claim (e.g., credit balance refund, setup error, etc.); dispute biller payment as non-fraud claim; dispute biller payment as fraud; review disclosures, including terms and conditions, privacy act, electronic disclosures and signature authorization; and register a complaint and receive resolution.

### Lender Reporting to Payment Server

In one embodiment, the lender may send a snapshot each day of customers paying through the payment server 101. The list includes either all customers or only customers with a change in status. This ensures the present server reserves only the amounts needed and are able to adapt to events such as loan modifications, early payments or bankruptcy.

In one embodiment, the lender reporting may include biller account number, payment account number, current balance, next payment amount, next payment due date, payment frequency, current maturity date if closed ended, amount past due, and account status.

### Payment Server Reporting to Lender

In one embodiment, the payment server 101 sends daily updates to lenders on the status of customers. The payment server reporting may include biller account number, payment account number, pending payment amount, direct deposit status (e.g., active, temporary disruption, permanent disruption, unknown disruption), income source name, such as employer name, employment insurance enrollment, employment insurance last payout amount, employment insurance last payout date, most recent payment amount from direct deposit, most recent payment amount from consumer deposit account, most recent payment amount from savings, most recent payment amount from insurance, and most recent payment amount from consumer credit account.

### Customer Events

In one embodiment, there are a number of events which may trigger a customer communication or payments account change.

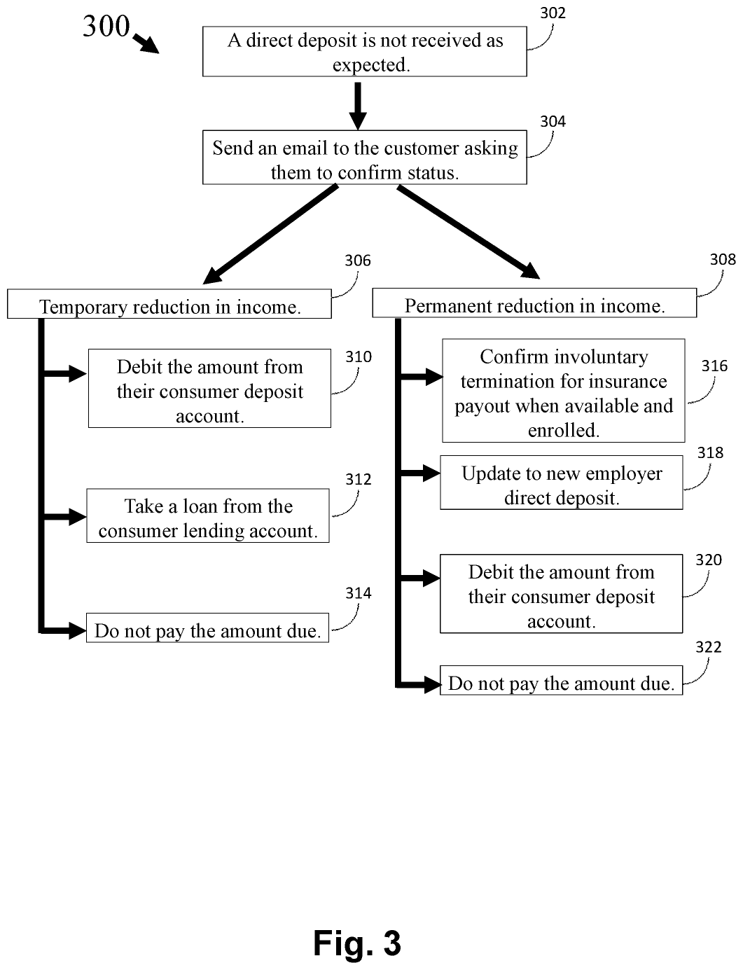

Referring to FIG. 3, this figure illustrates an exemplary customer event 300 which may trigger a customer communication or payments account change, according to an embodiment of the present disclosure.

In FIG. 3, the customer event starts with step 302, a direct deposit is not received as expected. Step 304 shows sending an email to the customer asking them to confirm status.

If there is a temporary reduction in income as shown in step 306, then the system may present options including debiting the amount from their consumer deposit account 109 in step 310, taking a loan from the consumer lending account 111 in step 312, and not pay the amount due in step 314.

If there is a permanent reduction in income as shown in the step 308, then the system may present the options including confirming involuntary termination for insurance payout when available and enrolled in step 316, updating to new employer direct deposit in step 318, debiting the amount from their consumer deposit account in step 320, and not paying the amount due in step 322.

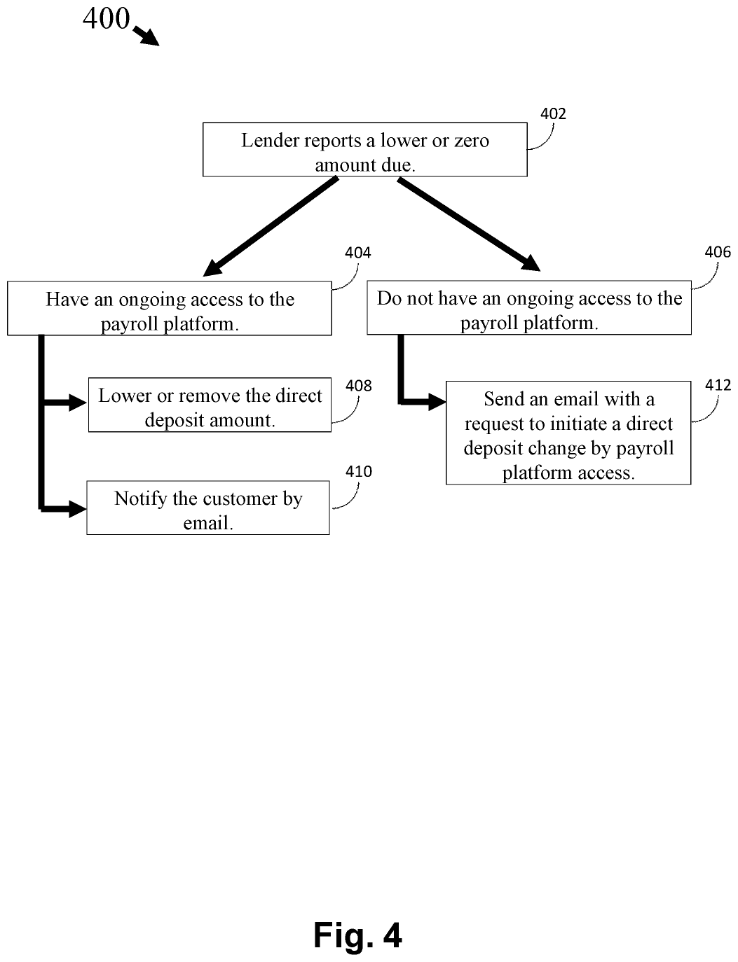

Referring to FIG. 4, this figure illustrates an exemplary customer event 400 which may trigger a customer communication or payments account change, according to an embodiment of the present disclosure.

In FIG. 4, the customer event starts with step 402 which includes a lender reporting a lower or zero amount due.

Step 404 shows that if the system has an ongoing access to the payroll platform, then the system may lower or remove the direct deposit amount in step 408 and notify the customer by email in step 410.

However, if the system does not have an ongoing access to the payroll platform in step 406, then the system sends an email with a request to initiate a direct deposit change by payroll platform access in step 412.

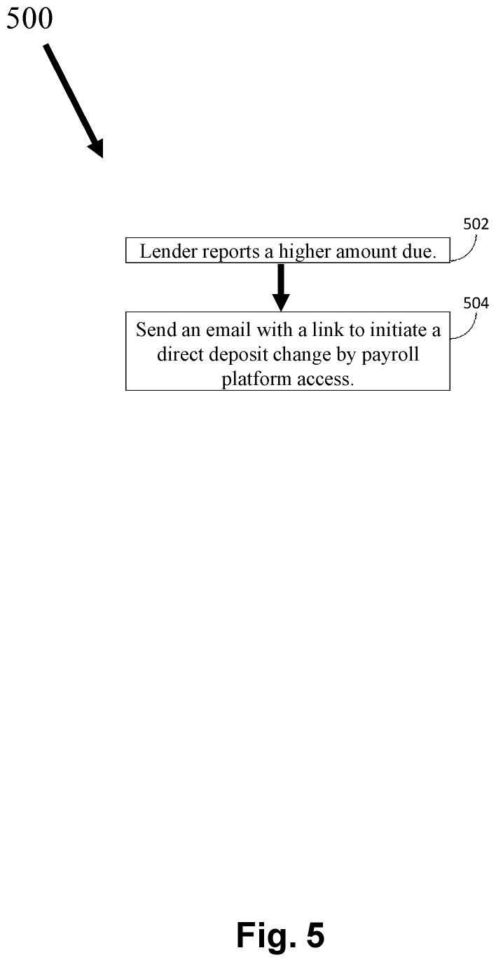

Referring to FIG. 5, this figure illustrates an exemplary customer event 500 which may trigger a customer communication or payments account change, according to an embodiment of the present disclosure.

In FIG. 5, the customer event starts with step 502 which includes a lender reporting a higher amount due. The system may send an email with a link to initiate a direct deposit change by payroll platform access as shown in step 504.

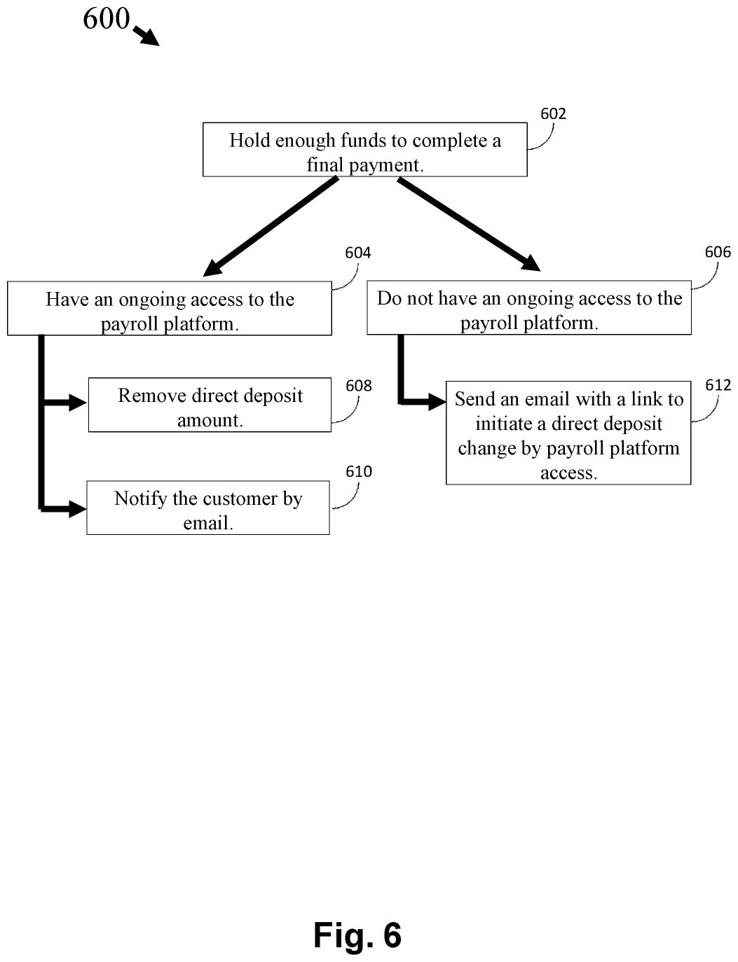

Referring to FIG. 6, this figure illustrates an exemplary customer event 600 which may trigger a customer communication or payments account change, according to an embodiment of the present disclosure.

In FIG. 6, the customer event starts with step 602 which includes holding enough funds to complete a final payment.

Step 604 shows that if the system has an ongoing access to the payroll platform, then the system may remove the direct deposit amount in step 608 and notify the customer by email in step 610.

However, if the system does not have an ongoing access to the payroll platform in step 606, then the system sends an email with a link to initiate a direct deposit change by payroll platform access in step 612.

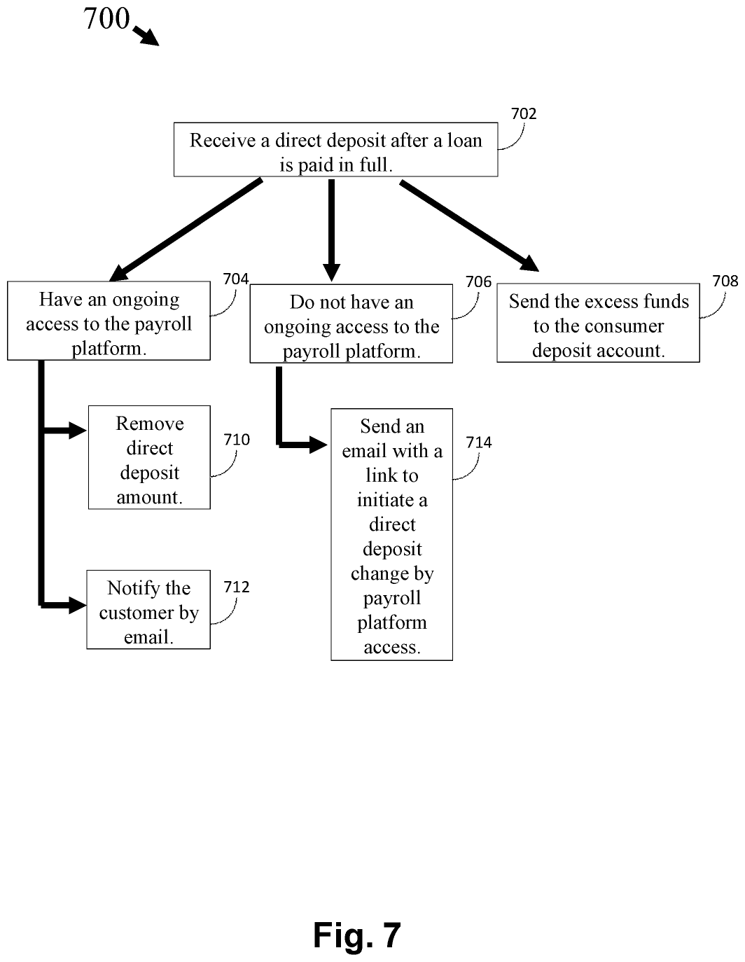

Referring to FIG. 7, this figure illustrates an exemplary customer event 700 which may trigger a customer communication or payments account change, according to an embodiment of the present disclosure.

In FIG. 7, the customer event starts with step 702 which includes receiving a direct deposit after a loan is paid in full.

Step 704 shows that if the system has an ongoing access to the payroll platform, then the system may remove the direct deposit amount in step 710 and notify the customer by email in step 712.

However, if the system does not have an ongoing access to the payroll platform in step 706, then the system sends an email with a link to initiate a direct deposit change by payroll platform access in step 714.

The system may also send the excess funds to the consumer deposit account 109 without confirming as shown in step 708 whether the system has an ongoing access to the payroll platform or not.

### Adding Savings to Customer Account

In one embodiment, from within the initial post-login online landing page or the account servicing page, the customer has the ability to see an offer for a savings account; read a product description of savings, including FDIC insurance tag, truth in savings information; follow standard direct deposit setup via payroll platform access to direct funds to the payment account; and perform all tasks consistent with consumer savings accounts.

### Adding Employment Insurance to Customer Account

In one embodiment, from within the initial post-login online landing page or the account servicing page, the customer has the ability to enroll in employment insurance, if available; review terms and conditions, disclosures, and eligibility requirements; see amount and duration of coverage benefit; see an offer for employment insurance, if not provided automatically as a benefit; read a product description; click on a partner link to apply for the product; follow standard direct deposit setup via payroll platform access to pay for the product, if needed; apply for benefit after a qualifying event; see register of payments made by the Insurance after a qualifying event; see remaining amount and duration of payment benefits available throughout a qualifying event coverage cycle; cancel the product; and register a complaint about the product or service.

### Adding Credit to Customer Account—

In one embodiment, from within the initial post-login online landing page or the account servicing page, the customer may see an offer for credit to cover gaps in ability to pay bills facilitated by the payment server 101; read a product description of extra protection line of credit, including truth in lending requirements; select amount of coverage desired; accept additional disclosures, terms and conditions, TILA agreement; follow direct deposit setup via payroll platform access to pay for the product, if needed; set up ACH payments for line of credit through linked bank account; and manage all required servicing transaction requirements through phone, email, or online account access.

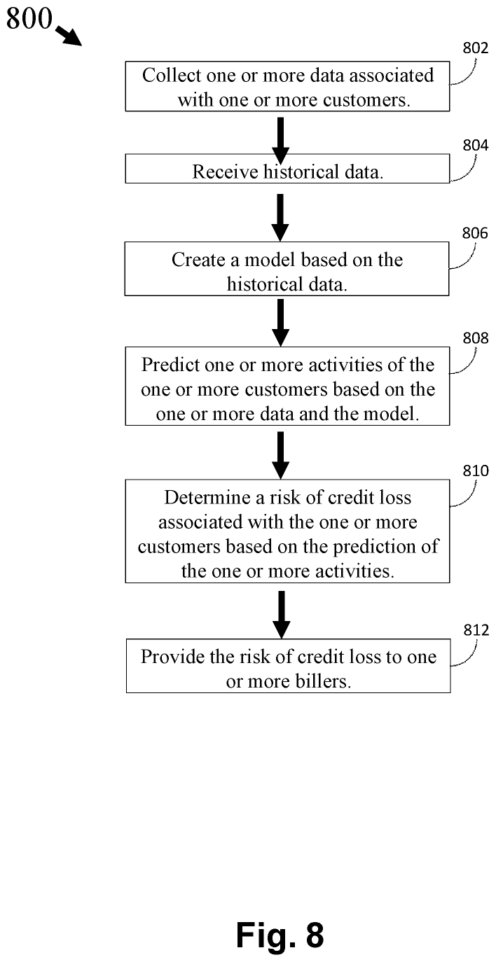

Referring to FIG. 8, this figure illustrates a flow chart of a system for determining a risk for credit loss associated with paying recurring bills through direct deposit repayments, according to an embodiment of the present disclosure.

At 802, one or more data associated with one or more customers are collected by a server. The server is a payment server. The one or more data include at least one or more of employment tenure, income, overtime pay, bonuses, trend in income, title, company, and industry.

At 804, historical data is received by the server. The historical data is previous data from previous customers using one or more platforms and the one or more platforms include a payment platform and a payroll platform. The historical data in the payment platform may also include how previous customers performed in making payments.

At 806, the system creates a model based on the historical data discussed in the step 804.

At 808, the server predicts one or more activities of the one or more customers based on the one or more data and the model discussed in the step 802 and 804. The one or more activities include at least one of the one or more customers remaining at current employer; and the one or more customers updating a direct deposit from a new employer.

At 810, the server determines a risk of credit loss associated with the one or more customers based on the prediction of the one or more activities discussed in the step 808.

At 812, the system provides the risk of credit loss to one or more billers. The billers determines whether each of the one or more customers pays on time based on the risk of the credit loss.

FIG. 9 is a schematic of a user device 900 of a customer for performing a method for determining a risk of credit loss associated with paying recurring bills through direct deposit repayments, according to an embodiment of the present disclosure.

An example of the user device 900 of a customer for performing the method for determining a risk of credit loss associated with paying recurring bills through direct deposit repayments is shown in FIG. 9. For example, the user device 900 can be a device provided to the customers or the billers discussed earlier. FIG. 9 is also a detailed block diagram illustrating an exemplary electronic user device 900. In certain embodiments, the user device 900 may be a smartphone, a desktop computer, or a tablet. However, the skilled artisan will appreciate that the features described herein may be adapted to be implemented on other devices (e.g., a laptop, a tablet, a server, an e-reader, a camera, a navigation device, etc.). The exemplary user device 900 of FIG. 9 includes a controller 910 and a wireless communication processor 902 connected to an antenna 901. A speaker 904 and a microphone 905 are connected to a voice processor 903.

The controller 910 may include one or more Central Processing Units (CPUs) and one or more Graphics Processing Units (GPUs) and may control each element in the user device 900 to perform functions related to communication control, audio signal processing, graphics processing, control for the audio signal processing, still and moving image processing and control, and other kinds of signal processing. The controller 910 may perform these functions by executing instructions stored in a memory 950. Alternatively or in addition to the local storage of the memory 950, the functions may be executed using instructions stored on an external device accessed on a network or on a non-transitory computer readable medium. In the present disclosure, the controller 910 may control which types of data requests display on the screen of the user device 900. The controller 910 may be used to train data from the user. The controller 910 may be used to identify a decision space for the user based on the data that the user provided. For example, as discussed above, the controller 910 of the user device 900 of the billers may use the user device 900 to one or more activities of the one or more customers based on the one or more data and the model. The one or more activities may include the one or more customers remaining at current employer and the one or more customers updating a direct deposit from a new employer

The memory 950 includes but is not limited to Read Only Memory (ROM), Random Access Memory (RAM), or a memory array including a combination of volatile and non-volatile memory units. The memory 950 may be utilized as working memory by the controller 910 while executing the processes, formula, and algorithms of the present disclosure. The memory may store user inputs from the user device 900, e.g., a particular origin and destination specified by the user. Additionally, the memory 950 may be used for short-term or long-term storage, e.g., of image data and information related thereto. The memory 950 may also be used to store the historical data discussed above. The memory 950 may also be used to store the one or more data discussed above and the one or more data may include employment tenure, income, overtime pay, bonuses, trend in income, title, company, and industry.

The user device 900 includes a control line CL and data line DL as internal communication bus lines. Control data to/from the controller 910 may be transmitted through the control line CL. The data line DL may be used for transmission of voice data, display data, etc.

The antenna 901 transmits/receives electromagnetic wave signals between base stations for performing radio-based communication, such as the various forms of cellular telephone communication. The wireless communication processor 902 controls the communication performed between the user device 900 and other external devices via the antenna 901. For example, the wireless communication processor 902 may control communication between base stations for cellular phone communication.

The speaker 904 emits an audio signal corresponding to audio data supplied from the voice processor 903. The microphone 905 detects surrounding audio and converts the detected audio into an audio signal. The audio signal may then be output to the voice processor 903 for further processing. The voice processor 903 demodulates and/or decodes the audio data read from the memory 950 or audio data received by the wireless communication processor 902 and/or a short-distance wireless communication processor 907. Additionally, the voice processor 903 may decode audio signals obtained by the microphone 905.

The exemplary user device 900 may also include a display 920, a touch panel 930, an operation key 940, and a short-distance communication processor 907 connected to an antenna 906. The display 920 may display the contents such as a corruption risk survey or questionnaires discussed earlier. The display 920 may be a Liquid Crystal Display (LCD), an organic electroluminescence display panel, or another display screen technology. In addition to displaying still and moving image data, the display 920 may display operational inputs, such as numbers or icons which may be used for control of the user device 900. The numbers or icons may be used for the respondent to answer the questionnaire. The display 920 may additionally display a GUI for a user to control aspects of the user device 900 and/or other devices. Further, the display 920 may display characters and images received by the user device 900 and/or stored in the memory 950 or accessed from an external device on a network. For example, the user device 900 may access a network such as the Internet and display text and/or images transmitted from a Web server.

The touch panel 930 may include a physical touch panel display screen and a touch panel driver. The touch panel 930 may include one or more touch sensors for detecting an input operation on an operation surface of the touch panel display screen. The touch panel 930 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 930 may detect when the stylus approaches/contacts the operation surface of the touch panel display (similar to the case in which a finger is used for the touch operation). The user such as a customer or a biller of the user device 900 may use the touch panel 930 to answer the questions provided by the user device 900.

In certain aspects of the present disclosure, the touch panel 930 may be disposed adjacent to the display 920 (e.g., laminated) or may be formed integrally with the display 920. For simplicity, the present disclosure assumes the touch panel 930 is formed integrally with the display 920 and therefore, examples discussed herein may describe touch operations being performed on the surface of the display 920 rather than the touch panel 930. However, the skilled artisan will appreciate that this is not limiting.

For simplicity, the present disclosure assumes the touch panel 930 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 930 may include transparent electrode touch sensors arranged in the X-Y direction on the surface of transparent sensor glass.

The touch panel driver may be included in the touch panel 930 for control processing related to the touch panel 930, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in certain embodiments, the touch panel 930 may detect a position of a user's finger around an edge of the display panel 920 (e.g., gripping a protective case that surrounds the display/touch panel). Signals may be transmitted by the touch panel driver, e.g. in response to a detection of a touch operation, in response to a query from another element based on timed data exchange, etc.

The touch panel 930 and the display 920 may be surrounded by a protective casing, which may also enclose the other elements included in the user device 900. In certain embodiments, a position of the user's fingers on the protective casing (but not directly on the surface of the display 920) may be detected by the touch panel 930 sensors. Accordingly, the controller 910 may perform display control processing described herein based on the detected position of the user's fingers gripping the casing. For example, an element in an interface may be moved to a new location within the interface (e.g., closer to one or more of the fingers) based on the detected finger position.

The operation key 940 may include one or more buttons or similar external control elements, which may generate an operation signal based on a detected input by the user. In addition to outputs from the touch panel 930, these operation signals may be supplied to the controller 910 for performing related processing and control.

The antenna 906 may transmit/receive electromagnetic wave signals to/from other external apparatuses, and the short-distance wireless communication processor 907 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 907.

The user device 900 may include a motion sensor 908. The motion sensor 908 may detect features of motion (i.e., one or more movements) of the user device 900. For example, the motion sensor 908 may include an accelerometer to detect acceleration, a gyroscope to detect angular velocity, a geomagnetic sensor to detect direction, a geo-location sensor to detect location, etc., or a combination thereof to detect motion of the user device 900. In certain embodiments, the motion sensor 908 may generate a detection signal that includes data representing the detected motion. For example, the motion sensor 908 may determine a number of distinct movements in a motion (e.g., from start of the series of movements to the stop, within a predetermined time interval, etc.), a number of physical shocks on the user device 900 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 910, whereby further processing may be performed based on data included in the detection signal. The motion sensor 908 can work in conjunction with a Global Positioning System (GPS) section 960. The information of the present position detected by the GPS section 960 is transmitted to the controller 910. An antenna 961 is connected to the GPS section 960 for receiving and transmitting signals to and from a GPS satellite.

The user device 900 may include a camera section 909, which includes a lens and shutter for capturing photographs of the surroundings around the user device 900. In an embodiment, the camera section 909 captures surroundings of an opposite side of the user device 900 from the user. The images of the captured photographs can be displayed on the display panel 920. A memory section saves the captured photographs. The memory section may reside within the camera section 909, or it may be part of the memory 950. The camera section 909 can be a separate feature attached to the user device 900 or it can be a built-in camera feature.

An example of a type of user's computer is shown in FIG. 10, which shows a schematic diagram of a generic computer system 1000. The user's computer may be a desktop computer for the ridesharing company described earlier.

The system 1000 can be used for the operations described in association with any of the method, according to one implementation. The system 1000 includes a processor 1010, a memory 1020, a storage device 1030, and an input/output device 1040. Each of the components 1010, 1020, 1030, and 1040 is interconnected using a system bus 1050. The processor 1010 is capable of processing instructions for execution within the system 1000. In one implementation, the processor 1010 is a single-threaded processor. In another implementation, the processor 1010 is a multi-threaded processor. The processor 1010 is capable of processing instructions stored in the memory 1020 or on the storage device 1030 to display graphical information for a user interface on the input/output device 1040.

As discussed earlier, the processor 1010 may be used to predict the one or more activities of the one or more customers based on the data. The processor 1010 may be used to create a model based on historical data from platforms such as payment platforms and payroll platforms as discussed earlier. The processor 1010 may be used to determine a risk of credit loss as discussed above in FIG. 8. The processor 1010 may execute the processes, formula, and algorithm in the present disclosure.

The memory 1020 stores information within the system 1000. In one implementation, the memory 1020 is a computer-readable medium. In one implementation, the memory 1020 is a volatile memory unit. In another implementation, the memory 1020 is a non-volatile memory unit.

The storage device 1030 is capable of providing mass storage for the system 1000. In one implementation, the storage device 1030 is a computer-readable medium. In various different implementations, the storage device 1030 may be a floppy disk device, a hard disk device, an optical disk device, or a tape device. The storage device 1030 may store historical data from the platforms such as payment platforms and payroll platforms as discussed earlier. The storage device 1030 may store one or more data associated with the customers discussed earlier. The storage device 1030 may store the determination of the risk of credit loss associated with the customers.

The input/output device 1040 provides input/output operations for the system 1000. In one implementation, the input/output device 1040 includes a keyboard and/or pointing device. In another implementation, the input/output device 1040 includes a display unit for displaying graphical user interfaces.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

FIG. 11 is a schematic of a hardware configuration of a device for performing a method, according to an embodiment of the present disclosure.

Next, a hardware description of a device according to exemplary embodiments is described with reference to FIG. 11. In FIG. 11, the device includes processing circuitry which may in turn include a CPU 1100 which performs the processes described above/below. As noted above, the processing circuitry performs the functionalities of the process in the present disclosure. The processing circuitry may determine that a risk of credit loss for each customer based on data collected in the payment server as discussed earlier.

The process data and instructions may be stored in memory 1102. These processes and instructions may also be stored on a storage medium disk 1104 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device communicates, such as a server or computer.

Further, the claimed advancements may be provided as a utility application, background daemon, or component of an operating system, or combination thereof, executing in conjunction with CPU 1100 and an operating system such as Microsoft Windows, UNIX, Solaris, LINUX, Apple MAC-OS and other systems known to those skilled in the art.

The hardware elements in order to achieve the device may be realized by various circuitry elements, known to those skilled in the art. For example, CPU 1100 may be a Xenon or Core processor from Intel of America or an Opteron processor from AMD of America, or may be other processor types that would be recognized by one of ordinary skill in the art. Alternatively, the CPU 1100 may be implemented on an FPGA, ASIC, PLD or using discrete logic circuits, as one of ordinary skill in the art would recognize. Further, CPU 1100 may be implemented as multiple processors cooperatively working in parallel to perform the instructions of the processes described above.

The device in FIG. 11 also includes a network controller 1106, such as an Intel Ethernet PRO network interface card from Intel Corporation of America, for interfacing with network for the payment network 100. As can be appreciated, the network for the payment network 100 can be a public network, such as the Internet, or a private network such as an LAN or WAN network, or any combination thereof and can also include PSTN or ISDN sub-networks. The network for the payment network 100 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The device further includes a display controller 1108, such as a NVIDIA GeForce GTX or Quadro graphics adaptor from NVIDIA Corporation of America for interfacing with display 1110, such as an LCD monitor. A general purpose I/O interface 1112 interfaces with a keyboard and/or mouse 1114 as well as a touch screen panel 1116 on or separate from display 1110. General purpose I/O interface also connects to a variety of peripherals 1118 including printers and scanners.

A sound controller 1120 is also provided in the device to interface with speakers/microphone 1122 thereby providing sounds and/or music.

The general purpose storage controller 1124 connects the storage medium disk 1104 with communication bus 1126, which may be an ISA, EISA, VESA, PCI, or similar, for interconnecting all of the components of the device. A description of the general features and functionality of the display 1110, keyboard and/or mouse 1114, as well as the display controller 1108, storage controller 1124, network controller 1106, sound controller 1120, and general purpose I/O interface 1112 is omitted herein for brevity as these features are known.

Particular embodiments of the subject matter have been described. Other embodiments are within the scope of the present disclosure. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

It is to be understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

Obviously, numerous modifications and variations are possible in light of the above teachings. It is therefore to be understood that within the scope of the appended claims, embodiments of the present disclosure may be practiced otherwise than as specifically described herein.

What is claimed is:

1. A method for determining a risk of credit loss associated with paying recurring bills through direct deposit repayments, comprising:
collecting, by a server, one or more data associated with one or more customers;
receiving, by the server, historical data;
creating a model based on the historical data;
predicting, by the server, one or more activities of the one or more customers based on the one or more data and the model;
determining, by the server, a risk of credit loss associated with the one or more customers based on the prediction of the one or more activities; and
providing the risk of credit loss to one or more billers.

2. The method of claim 1, wherein the server is a payment server.

3. The method of claim 1, wherein the one or more data include at least one or more of employment tenure, income, overtime pay, bonuses, trend in income, title, company, and industry.

4. The method of claim 1, wherein the historical data is data from previous customers using one or more platforms, the one or more platforms including a payment platform and a payroll platform

5. The method of claim 1, wherein one or more activities include at least one of:
the one or more customers remaining at current employer; and
the one or more customers updating a direct deposit from a new employer.

6. The method of claim 1, wherein the server further tracking each of the one or more customers remains employed and pays recurring bills through direct deposit repayments.

7. The method of claim 1, wherein the billers determines whether each of the one or more customers pays on time based on the risk of the credit loss.

8. A system for predictive corruption risk assessment, comprising:
processing circuitry configured to
collect, by a server, one or more data associated with one or more customers;
receive, by the server, historical data;
create a model based on the historical data;
predict, by the server, one or more activities of the one or more customers based on the one or more data and the model;
determine, by the server, a risk of credit loss associated with the one or more customers based on the prediction of the one or more activities; and
provide the risk of credit loss to one or more billers.

9. The system of claim 8, wherein the server is a payment server.

10. The system of claim 8, wherein the one or more data include at least one or more of employment tenure, income, overtime pay, bonuses, trend in income, title, company, and industry.

11. The system of claim 8, wherein the historical data is data from previous customers using one or more platforms, the one or more platforms including a payment platform and a payroll platform

12. The system of claim 8, wherein one or more activities include at least one of:
the one or more customers remaining at current employer; and
the one or more customers updating a direct deposit from a new employer.

13. The system of claim 8, wherein the server further tracking each of the one or more customers remains employed and pays recurring bills through direct deposit repayments.

14. The method of claim 8, wherein the billers determines whether each of the one or more customers pays on time based on the risk of the credit loss.

15. A non-transitory computer-readable storage medium storing computer-readable instructions that, when executed by a computer, cause the computer to perform a method, the method comprising:
collecting, by a server, one or more data associated with one or more customers;
receiving, by the server, historical data;
creating a model based on the historical data;
predicting, by the server, one or more activities of the one or more customers based on the one or more data and the model;
determining, by the server, a risk of credit loss associated with the one or more customers based on the prediction of the one or more activities; and
providing the risk of credit loss to one or more billers.

16. The non-transitory computer-readable medium of claim 15, wherein the server is a payment server.

17. The non-transitory computer-readable medium of claim 15, wherein the one or more data include at least one or more of employment tenure, income, overtime pay, bonuses, trend in income, title, company, and industry.

18. The non-transitory computer-readable medium of claim 15, wherein one or more activities include at least one of:
the one or more customers remaining at current employer; and
the one or more customers updating a direct deposit from a new employer.
